(19) United States
(12) Patent Application Publication
(10) Pub. No.: US 2009/0019065 A1
(43) Pub. Date: Jan. 15, 2009

(54) HETEROGENEOUS DATA COLLECTION AND DATA MINING PLATFORM

(76) Inventor: Demetrios SAPOUNAS, Leesburg, VA (US)

Correspondence Address: ARENT FOX LLP, 1050 CONNECTICUT AVENUE, N.W., SUITE 400, WASHINGTON, DC, 20036, US

(21) Appl. No.: 12/112,705

(22) Filed: Apr. 30, 2008

Related U.S. Application Data
(60) Provisional application No. 60/924,083, filed on Apr. 30, 2007.
(60) Provisional application No. 60/924,125, filed on May 1, 2007.
(60) Provisional application No. 61/006,094, filed on Dec. 19, 2007.
(60) Provisional application No. 61/006,095, filed on Dec. 19, 2007.
(60) Provisional application No. 61/006,097, filed on Dec. 19, 2007.
(60) Provisional application No. 61/006,099, filed on Dec. 19, 2007.
(60) Provisional application No. 61/006,100, filed on Dec. 19, 2007.
(60) Provisional application No. 61/006,098, filed on Dec. 19, 2007.
(60) Provisional application No. 61/006,977, filed on Feb. 8, 2008.

(51) Int. Cl. G06F 17/30

(52) U.S. Cl. 707/100; 707/E17.044

(57) ABSTRACT

Systems, methods and computer program products for collecting, storing, processing/analyzing, securely transmitting and presenting heterogeneous data within an open system architecture are disclosed. The collection of heterogeneous data from numerous remote collection points and aggregating the collected data for displaying in a user-friendly interface are provided. The systems, methods and computer program products disclosed herein, in varying aspects, readily lend themselves to incremental component and functionality modifications, which allow for increased data sources, accuracy, reliability and utility of the collected information, further solidifying the uniqueness and desirability of the systems, methods and computer program products.

### CROSS-REFERENCE TO RELATED APPLICATIONS

This application claims the benefit of, and is related to, the following of Applicant's co-pending applications:

U.S. Provisional Patent Application No. 61/006,094, titled “Improved Communications and Biosensor Device,” filed Dec. 19, 2007;

U.S. Provisional Patent Application No. 61/006,095, titled “Gateway Device for Discrete and Continuous Monitoring of Ambient Data with Emergency Functions,” filed Dec. 19, 2007;

U.S. Provisional Patent Application No. 61/006,097, titled “Gateway Device for Discrete and Continuous Monitoring of Physiological Data,” filed Dec. 19, 2007;

U.S. Provisional Patent Application No. 61/006,099, titled “Method and System for Discrete and Continuous Monitoring of Physiological and Ambient Data,” filed Dec. 19, 2007;

U.S. Provisional Patent Application No. 61/006,100, titled “User Interface for System for Discrete and Continuous Monitoring of Physiological and Ambient Data,” filed Dec. 19, 2007;

U.S. Provisional Patent Application No. 61/006,098, titled “Method and System for Data Transmission for Use with Biosensor Device or Gateway,” filed Dec. 19, 2007;

U.S. Provisional Patent Application No. 61/006,977, titled “Body Patch for Non-Invasive Physiological Data Readings,” filed Feb. 8, 2008;

U.S. Non-provisional patent application Ser. No. 12/010,447, titled “System and Method for Physiological Data Readings, Transmission and Presentation,” filed Jan. 25, 2008;

U.S. Non-provisional patent application Ser. No. 12/068,285, titled “System and Method for Physiological Data Readings, Transmission and Presentation,” filed Feb. 5, 2008; and

U.S. Non-provisional patent application Ser. No. 12/068,969, titled “Physiological Data Processing Architecture for Situation Awareness,” filed Feb. 13, 2008, each of which is incorporated by reference herein in its entirety.

### BACKGROUND OF THE INVENTION

1. Field of Invention

This invention is generally directed to systems and methods for data collection, data processing, analysis and mining of data obtained from heterogeneous and disparate systems and devices. The invention provides a framework and an open interface for communication and integration of data received from heterogeneous devices, whether those are wireless or physically connected to a network. In addition to the collection and aggregation of the data, the invention provides for analysis and mining of the data, by defining operations and transformations on the data. This lends to realizing value from the data, supporting the purposes for which the data was collected. This invention has no limitation to the number or nature and location of the devices used for data collection, and thus, can scale to accommodate any number, resulting in higher accuracy, increased functionality and more data for data mining purposes.

2. Related Art

Data processing is a well-established art in the computer field. It refers to the processing of the actual raw data and it is customary to define a set of transformations on that data, to serve a specific purpose. This is accomplished through computer systems, custom and off-the-shelf algorithms (computer programs) and possibly database systems. The resulting process is defined by a data flow and processes at various steps of the data flow and produces the results defined by the requirements. However, there are currently no available methods or systems that wirelessly collect heterogeneous data from numerous remote collection points, aggregate raw data and processed data for processing/analyzing of the heterogeneous data and present the data in a user-friendly interface to support analysis and decision making in a single system architecture.

### SUMMARY OF THE INVENTION

In light of the above described problems and unmet needs, aspects of the present invention provide an open and standards-based computing architecture and methods for collecting, storing, processing/analyzing, securely transmitting and presenting data. The described systems are designed such that they can serve multiple constituencies, ranging from scientists and researchers to business professionals and consumers.

Aspects of the present invention are directed toward decision support computer systems and application programs for collecting, analyzing, storing, and displaying in a user-friendly interface, heterogeneous data. Aspects of the present invention include the aggregation of such data from numerous remote collection points by receiving data transmitted over computer networks. An open interface is defined, which enables the receipt and processing of data irrespective of the source. Aspects of the present invention also include the dissemination of data through similar methods. The architecture consists of a number of networked computer systems, each configured to perform a specific set of functions. No system by itself is capable of providing the functionality and capabilities described herein; only the collection of all systems in the defined architecture can produce the desired results.

The architecture may consist of commercial off-the-shelf (COTS) network and computer systems (hardware) and a collection of custom and COTS computer programs (software). Custom software may define the data flows and operations on the data that achieve the objectives of this concept. This custom software may collect the data from remote collection points, process and store it in a data warehouse, thereby making the data easily accessible for online and batch processing. Analytical processing on the data is also performed to uncover relationships and trends hidden in the aggregate data, and also defines the methods of presenting and communicating the findings to human beings through a user-friendly interface.

Among others, an advantage of aspects of the present invention is that it provides a specific computing architecture and applies principles of data processing, adapted and customized for the classes of collected data.

Another advantage of aspects of the present invention is the described aggregation of raw and processed data from disparate collection points and processes for transforming the data and presenting it in a user-friendly interface to support analysis and decision making.

Another advantage of aspects of the present invention is a decision support system to be used by business users and consumers in the process of reaching conclusions derived from the underlying data.

Yet another advantage of aspects of the present invention is an analytical environment for raw and processed data analysis, which contributes to research and development studies and advances for scientific and business purposes.

Additional advantages and novel features of aspects of the invention will be set forth in part in the description that follows, and in part will become more apparent to those skilled in the art upon examination of the following or upon learning by practice of the invention.

### BRIEF DESCRIPTION OF THE DRAWINGS

Exemplary variations of the systems and methods will be described in detail, with reference to the following figures, wherein:

FIG. 1 is a high-level depiction of a system architecture according to an exemplary aspect of the present invention.

FIG. 2 presents an exemplary system diagram of various hardware components and other features, for use in accordance with an implementation of aspects of the present invention; and

FIG. 3 is a high-level data and operational flow chart according to an exemplary aspect of the present invention.

FIG. 4 is an operational data analysis flow chart according to an exemplary aspect of the present invention.

FIG. 5 is a data analysis and data mining flow chart according to an exemplary aspect of the present invention.

FIG. 6 is a high-level depiction of a system architecture according an exemplary aspect of the present invention.

FIG. 7 is a high-level depiction of a system architecture according an exemplary aspect of the present invention.

FIG. 8 is a high-level depiction of a system architecture according an exemplary aspect of the present invention.

FIG. 9 is a high-level depiction of a system architecture according an exemplary aspect of the present invention.

FIG. 10 is a high-level depiction of a system architecture according an exemplary aspect of the present invention.

### DETAILED DESCRIPTION OF PREFERRED EMBODIMENTS

These and other features and advantages of this invention are described in, or are apparent from, the following detailed description of various exemplary embodiments.

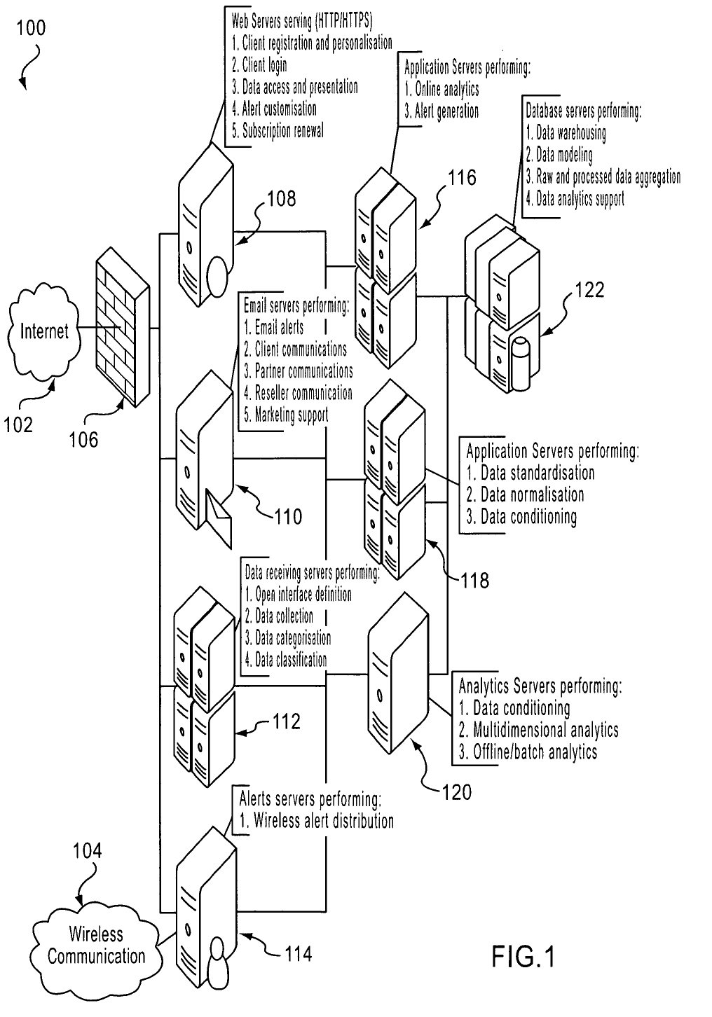

A general depiction of the architecture is provided in FIG. 1. This represents the primary hardware components of the architecture.

The system architecture 100 defines two methods of communicating with external devices and users: one through the Internet 102, which is used for incoming data from the collection devices and for providing user access to the data; and one through a wireless network 104, which is used for outgoing alerts and other notification messages destined for subscribers, call centers and other destinations. Among other types, network 104 may be cellular networks (CDMA, GSM and others), ZigBee (802.15.4), Wi-Fi (802.11x), ANT, Bluetooth, and Ultra Wide Band, among others.

On the Internet 102 side, all traffic is routed through a firewall 106 configured such that only authorized connections can gain access to the systems and data. The purpose of the firewall 106 is to provide security and restrict unauthorized access to the systems and client data. Behind the firewall 106 there is also an intrusion detection system (IDS), not shown in FIG. 1, which provides another defense barrier against unauthorized access.

The system architecture 100 represents a typical multi-tier environment, depicted here as having three tiers, where different functions and different levels of control are implemented at each tier. In FIG. 1 the first tier represents outward facing functions. These include web servers 108 for the presentation layer of the application and the subscriber portal. The web servers 108 enable subscribers to authenticate, manage subscriptions, define profiles, and gain access to the collected data and the reporting capabilities. Another component of this tier is email servers 110, used for communicating with subscribers and business partners. Data receipt servers 112 are an important component of this tier and of the whole architecture 100. This may be where the open interface is published and where data is received for follow-on processing.

This tier may also contain the alerts servers 114, which may construct and transmit alerts based on a combination of analysis on a subscriber's data and corresponding personalized profile settings. Among others transmission of alerts may be accomplished primarily through cellular connections, though other protocols like wireless, voice over Internet protocol (IP) (VoIP), ZigBee (802.15.4), Cellular (CDMA, GSM and others), Wi-Fi (802.11x), ANT, Bluetooth, and Ultra Wide Band, among others.

The second tier of the architecture 100 may consist of application servers 116 responsible for performing the majority of processing on the data and responding to requests coming from the previous tier. A set of application servers 116 may be assigned to perform analysis of incoming data and generate any alerts based on the analysis, plus process subscriber requests for online analytics and data presentation. This may effectively be the decision support element of the architecture 100, which among other things may empower subscribers to formulate action plans based on an analysis of the collected data. Another set of application servers 118 may be responsible for aggregating all the data, normalising it and preparing the data for storage in the data warehouse and for analysis, whether online or offline (batch). A third set of application servers 120 may be responsible for all the data processing and data analytics.

The third tier of the architecture 100 contains the data collected, which may be housed in a data warehouse. Here database servers 122 define data models for data storage and retrieval and the access point into the data. At this tier the security level may also be the highest, to safeguard and detect against unauthorized access.

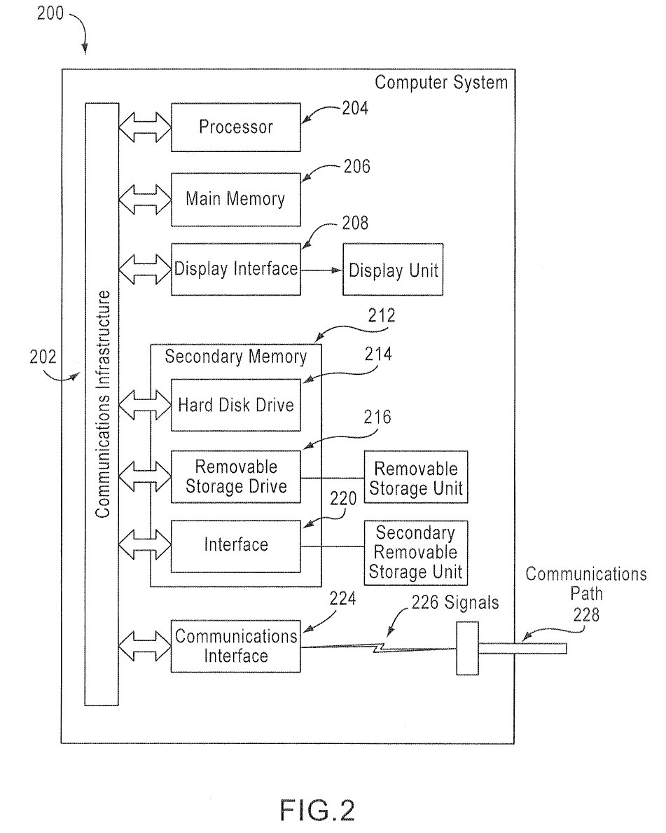

The system architecture 100 describes a number of servers, which in effect are computer systems similar to the block diagram, in FIG. 2, depicting various computer system components for use with an exemplary implementation of a data collection, analysis, storage, presentation, distribution, and communications system, in accordance with aspects of the present invention.

The computer architecture of aspects of the present invention may be implemented using hardware, software, or a combination thereof, and may be implemented in one or more computer systems or other processing systems. One aspect of the present invention is directed toward one or more computer systems capable of carrying out the functionality described herein. An example of such a computer system 100 is shown in FIG. 2.

The computer system 200 includes one or more processors, such as processor 204. Processor 204 is connected to a communications infrastructure 202 (e.g., a communications bus, cross-over bar, or network). Various software aspects are described in terms of this exemplary computer system. After reading this description, it will become apparent to a person skilled in the relevant art(s) how to implement aspects of the present invention using other computer systems and/or architectures.

Computer system 200 can include a display interface 208 that forwards graphics, text, and other data from the communication infrastructure 202 (or from a frame buffer not shown) for display on display unit 210.

Computer system 200 also includes a main memory 206, preferably random access memory (RAM), and may also include a secondary memory 212. The secondary memory 212 may include, for example, a hard disk drive 214 and/or a removable storage drive 216, representing a floppy disk drive, a magnetic tape drive, an optical disk drive, etc. The removable storage drive 216 reads from and/or writes to a removable storage unit 218 in a well known manner. Removable storage unit 218 represents a floppy disk, magnetic tape, optical disk, etc. which is read by and written to by removable storage drive 216. As will be appreciated, the removable storage unit 218 includes a computer usable storage medium having stored therein computer software and/or data.

In alternative aspects, secondary memory 212 may include other similar devices for allowing computer programs or other instructions to be loaded into computer system 200. Such devices may include, for example, a secondary removable storage unit 222 and an interface 220. Examples of such may include a program cartridge and cartridge interface (such as that found in video game devices), a removable memory chip (such as an erasable programmable read only memory (EPROM), or programmable read only memory (PROM)) and associated socket, and other secondary removable storage units 222 and interfaces 220, which allow software and data to be transferred from the secondary removable storage unit 222 to computer system 200.

Computer system 200 may also include a communications interface 224. Communications interface 224 allows software and data to be transferred between computer system 200 and external devices. Examples of communications interface 224 may include a modem, a network interface (such as an Ethernet card), a communications port, a Personal Computer Memory Card International Association (PCMCIA) slot and card, etc. Software and data transferred via communications interface 224 are in the form of signals 226 which may be electronic, electromagnetic, optical or other signals capable of being received by communications interface 224. These signals 226 are provided to communications interface 224 via a communications path (e.g., channel) 228. This channel 228 carries signals 226 and may be implemented using wire or cable, fiber optics, a telephone line, a cellular link, an radio frequency (RF) link and other communications channels.

In this document, the terms “computer program medium” and “computer usable medium” are used to generally refer to media such as removable storage drive 216, a hard disk installed in hard disk drive 214, and signals 226. These computer program products provide software to computer system 200. The invention is directed to such computer program products.

Computer programs (also referred to as computer control logic) are stored in main memory 206 and/or secondary memory 212. Computer programs may also be received via communications interface 224. Such computer programs, when executed, enable the computer system 200 to perform the features of the present invention, as discussed herein. In particular, the computer programs, when executed, enable the processor 204 to perform the features of the present invention. Accordingly, such computer programs represent controllers of the computer system 200.

In an aspect of the present invention that is implemented using software, the software may be stored in a computer program product and loaded into computer system 200 using removable storage drive 216, hard drive 214 or communications interface 224. The control logic (software), when executed by the processor 204, causes the processor 204 to perform the functions of the invention as described herein.

In another aspect, the present invention is implemented primarily in hardware using, for example, hardware components such as application specific integrated circuits (ASICs). Implementation of the hardware state machine so as to perform the functions described herein will be apparent to persons skilled in the relevant art(s).

In yet another aspect, the present invention is implemented using a combination of both hardware and software.

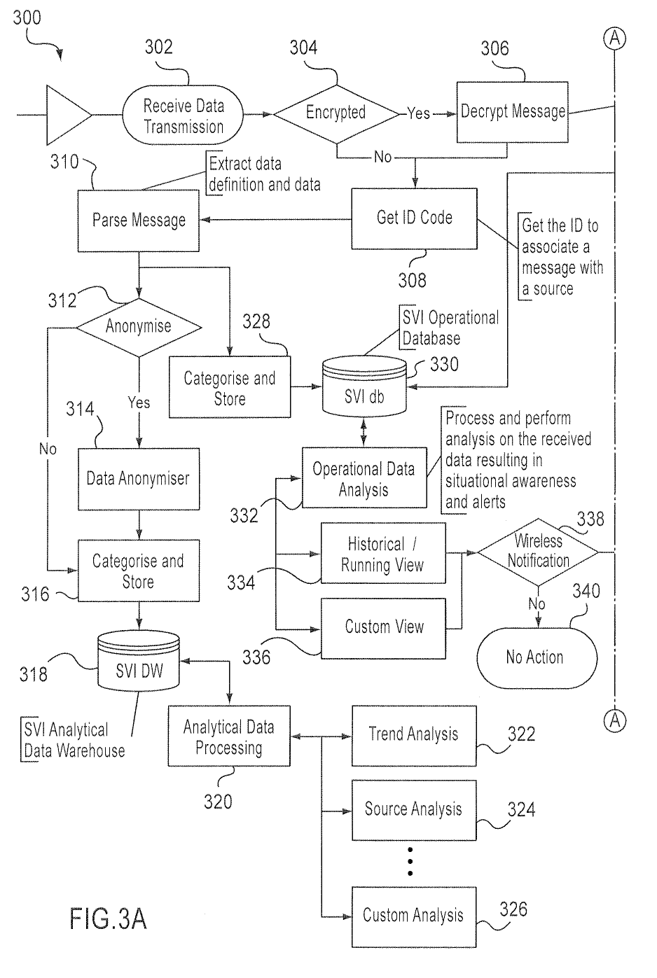

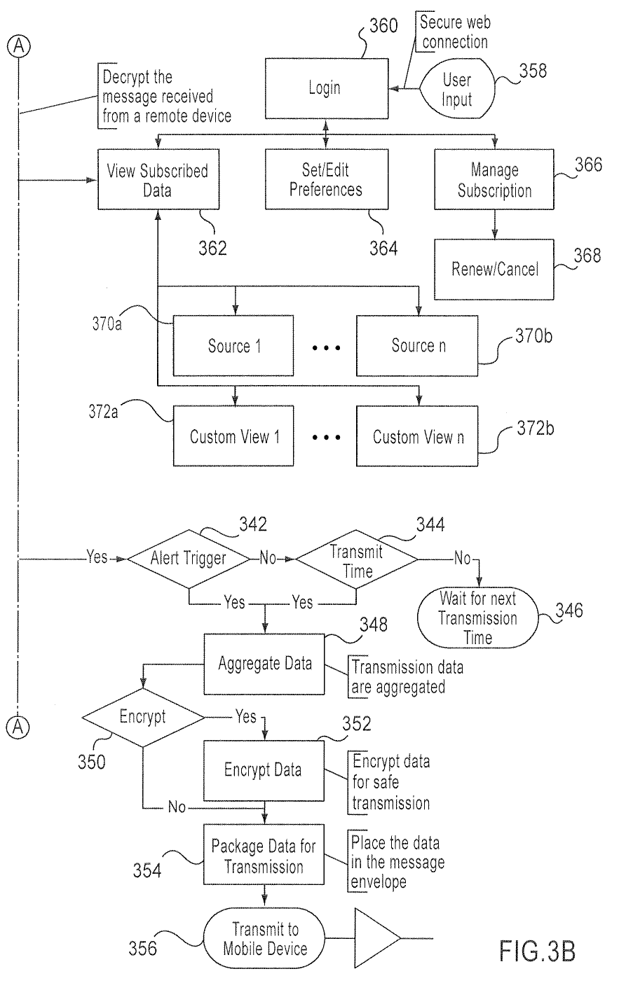

The system architecture 100, presented in the previous paragraphs, also describes a number of data flows and operations on the data, which enhance the value of the data collected and transmitted to the data centre. FIG. 3 provides a pictorial representation of the overall data flow 300, indicating where data transformations occur.

First of all it is important to note that there may be at least two entry and two exit points in the data flow 300. The two possible entry points are depicted by the “Receive Data Transmission” (block 302) and “User Input” (block 358). Block 302 may be only an entry point and represents the path used for receiving data collected and transmitted from a plurality of remote devices and sources. Block 358 is both an entry and exit point, representing a user interface for user interaction with the system. Two possible exit points are depicted by the “User Input” (block 358) and “transmit to Mobile Device” (block 356). Block 358 was described previously. Block 356 may be only an exit point and may be used for transmitting information to remote devices, which may include among other devices smart cell-phones, and personal digital assistants (PDAs).

First a description of the data flow from block 302 or the “Receive Data Transmission” point is provided. As stated, this may be the entry point for receiving data transmitted from remote data collection devices. When the data arrives, the first check performed, in step 304, is to determine whether it is encrypted or not. It is important to encrypt transmitted data for increased security. If the data is encrypted, the proper decryption algorithms in step 306 are used to decrypt the data so it can be processed further. If the data is not encrypted, then the decryption step 306 is bypassed.

The next step is to identify the data in step 308. Identification means to create an association between the transmitted message and the data source. Since the data is transmitted without specific identifying information other than an ID code, this ID is used to identify the class of data collection device and thus the class of data contained in the message. By using the ID code for transmitted data and by only connecting data, such as medical data, with personal identification material after receipt in the system, confidential information can be further protected.

The next step is to parse the message information and extract the data contained in the message in step 310, for further processing. Parsing refers to the process of traversing the message definition and fields, to extract the respective values. Messages are defined through an extensible markup language (XML) schema. This XML schema may be published so that any data collection and transmission source can send information to the platform, described in an aspect of the present invention, as long as such information is transmitted in messages conforming to the XML schema. Among other things, this will allow the system to collect data from multiple types of remote devices from multiple manufacturers.

At this point the data flow 300 may split into two separate paths, each describing a different use for the data. One path may directly support individual subscriber operations and the other may address the needs for broader analytical processing and data warehousing. First, aspects of a subscriber support operation data flow are described.

### Operational Analysis

Up to this point the association between the received data and a source has been established in step 308. Now the computer programs resident on system architecture 100 may process the data elements in association with a data class (weather, financial, entertainment, medical, etc.), and the time span for the data. This then enables storing the data in the operational database in step 330 for follow-on analysis.

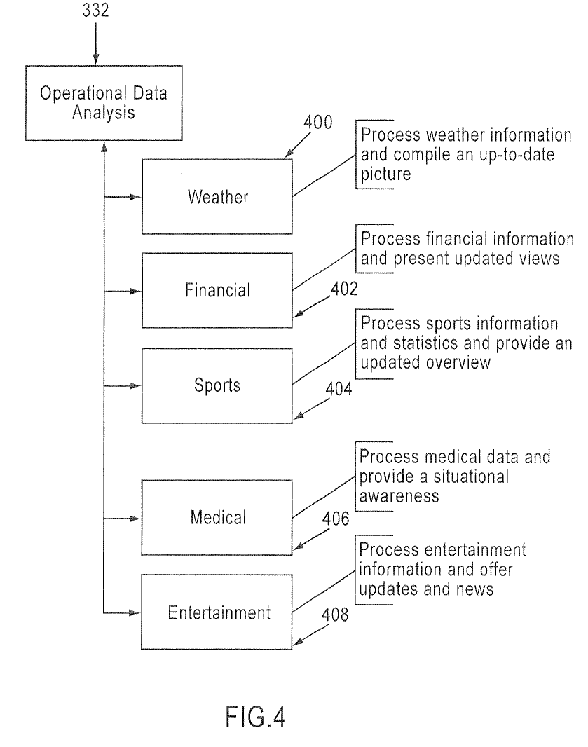

FIG. 4 provides an expanded detail of representative elements of the operational analysis data flow.

The Analysis of the data is controlled by the Operational Data Analyses processes in step 332, which may operate on the respective data classes by invoking the respective analysis algorithms. FIG. 4 presents five exemplary data/information classes: weather, financial, sports, medical and entertainment. There is no limitation to the data classes handled by the operational analysis process, since the XML schema can be used for defining the data class.

For example, weather analysis in step 400 may process the weather data received and updates the current and future information, based on this data. This analysis is performed based on location and time stamp information, plus algorithms for compiling a current state and future prediction for a particular locale.

Financial data analysis in step 402 may process the data, based on the subclasses of this data. The financial data class may represent a large set of data classes, including stock market, interest rates, commodities, and associated news. The analysis operates on the sub-classes of this data and provides aggregates and subclass specific views.

Similarly, sports data in step 404 may also define a number of subclasses, identified by specific sports. The analysis operates on the respective subclasses and compiles the received data so that both aggregate and detailed views are available. Detailed views are defined by the data subclasses, i.e. the individual sports categories.

Medical data in step 406 may represent multi-faceted data and subclasses, many of which have specific requirements including security/privacy, accuracy and timeliness, plus may be governed by Government regulations. Subclasses of medical data may include general market information and studies, but it may also include data associated with individuals. The latter class of data may represent information collected due to wellness activities and monitoring, where individuals collect such data during the course of regular activities designed to maintain and/or improve their state of health and conditioning. For example, the medical data may be either or a combination of ambient temperature, skin temperature, humidity, heart rate, physical activity, movement, location, blood pressure, blood-oxygen level, respiration, or core body temperature of a system user. Another use is for monitoring the general well-being of individuals who may be of frail health and whose data may be accessed by care givers and/or medical professionals. The operational analysis of such individual data would provide an up-to-date situational awareness for the respective individual.

Entertainment data in step 408 may also consist of a number of subclasses, as defined by the various entertainment categories and further defined by locale and time span. The analysis of this class of data operates on the subclasses and on the aggregate.

After the analysis of the data is performed in step 332, the data flow continues, as shown in FIG. 3. At this point the analysis results may be prepared for presentation and communication. For presentation purposes multiple views are possible, including Historical/Running View in step 334, which includes data for the time period defined in the user profile and Custom View in step 336, which includes data (classes and subclasses) defined by the user. The rest of the data flow 300 is driven by the user's level of service and profile.

One of the options is for a user to receive notifications to wireless devices in step 338, for user-defined triggers in the data, based on trigger parameters defined in the user profile. Thus, if receiving such notifications is not part of the service level for a user, no further action is taken in step 340 and the data flow terminates. If the service level includes wireless notifications, then the processing continues and the notification messages are created and sent.

First, the system 100 checks whether there are triggers in step 342, to warrant an immediate transmission. For example, a subscriber may define a trigger as a heart rate falling below a pre-defined rate. The incoming collected data is analyzed to determine if the data includes data meeting the definition. If that is not the case, then the system 100 checks in step 344 whether it is time to initiate a transmission, based on a predefined transmission schedule. If it is not time for transmission, the system 100 will wait in step 346 until the next transmission time or an out of sequence trigger event, to start the transmission process again.

If it is time to send a transmission or there is a need to initiate an out-of-sequence transmission due to a trigger event, then the data flow follows those steps. First all, the pertinent data is aggregated in step 348. This includes the data readings and the analysis results, so that the user receiving this information can formulate an educated decision as to the next steps and actions to be taken. For example, if medical data is collected, the user may determine if the transmission received is an emergency or if it merely warrants a check up or further monitoring of the subscriber.

Following the aggregation of all the data and results in step 348, the system 100 may check, in step 352, to see whether the user device can handle encrypted data, which is driven by the user profile. In the user profile, the user may define whether encrypted data transmissions can be processed properly, and also the encryption algorithm to be used. Thus, if encryption is to be used, the data is encrypted in step 352, before going to the next step.

Now that the data and the message content are ready, the message itself may be assembled for transmission. In step 354, the message envelope and header information are wrapped around the content, so that the transmission protocol to be used for sending the message can accurately route the message to the intended recipient. As soon as the message is ready, it may be transmitted through the network in step 356, to arrive at the defined destination. This may also be one of the two exit points from the data flow.

### Data Warehousing and Analytics

So far, the system has established associations between the received data the individual data sources, and individual subscribers in step 308. For certain aspects of data flow 300, it may be important to anonymise certain data classes, while maintaining demographic information. Some data classes, most notably medical data contain associations to individual subscribers and other persons who the data belong. Through the association of the data to a subscriber in step 308, all the demographic information about this subscriber is known. To anonymise the data in step 314, identifying information, such as name, address, phone number, SSN or other identification numbers, may be removed from the data, leaving only the raw data, source device information and the demographic data. Now the computer programs may conduct group analysis of the anoymised data examining the data to determine the collection source, as it relates to the type of data, what it measures (temperature, motion, heart rate, etc.), the time period covered, as in time of day, and separate the data into those categories in step 316. This then enables storing, also in step 316, the data in the analytical data warehouse 318 for follow-on analysis. Other data classes may not require anonymisation. Such classes include, among others, financial, weather and sports data.

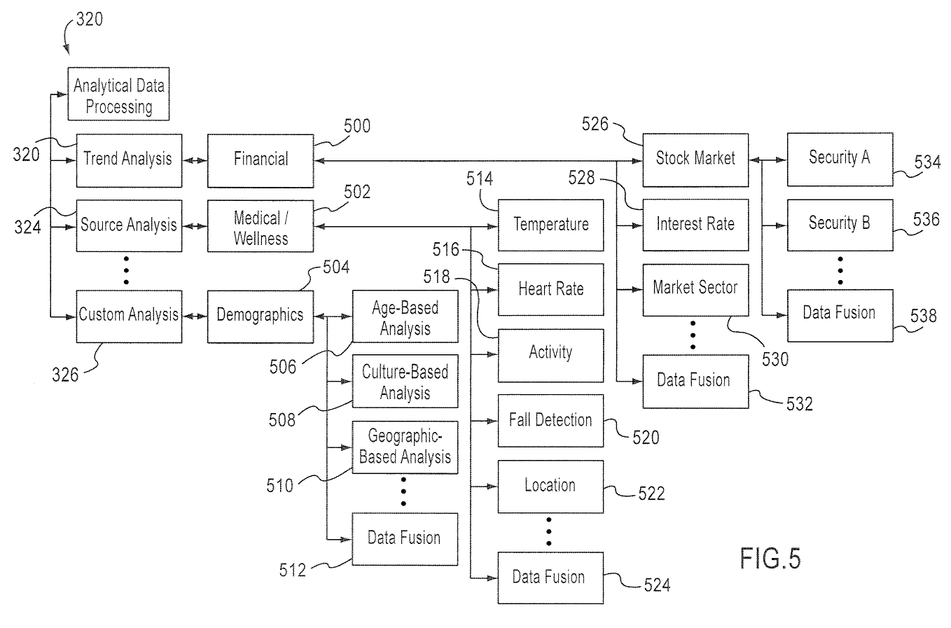

Now that the data is available, the analytical data processing in step 320, depicted in FIG. 5, may take place. Analytical data processing 320 defines the operations on the anonymised data, to support non-consumer uses, including product enhancements, research and development, population and age studies, and drug discovery. The analytical data processing in step 320 includes operations and transformations on the data in the data warehouse and makes use of complex data schemas and analytical stores (also referred to as data cubes), plus complex computer algorithms. FIG. 5 depicts only a small subset of the possible set of analytical processing.

One type of analysis is Trend Analysis as shown in block 322. Trend Analysis may be used for identifying patterns in the anonymised data over time, with the objective of associating trends to certain events. The trend analysis can define operations on a single source or multiple data sources, and also combine all available data to reach results contributing to decision support. The Trend Analysis data flow in FIG. 5 depicts analysis based on the financial class of data (block 500) and further demonstrates the analysis based on stock market data (block 526), for a single security (block 534) or combination of securities (block 536). Trend analysis may also be done for an individual's collected data, which may be accessed by the subscriber. Data Fusion (block 532) could also be used for trend analysis, which makes use of multiple data subclasses, including many more than those shown in the FIG. 5. It is worth noting that it is not the intent of this document to provide an exhaustive listing of all possible data classes and subclasses, rather only a representative sample. The reader can easily extrapolate that additional data classes and subclasses would be analysed through similar data flows and underlying algorithms.

The Source Analysis data flow, shown in block 324, is also expanded to demonstrate analysis on the Medical or Wellness class of data, as shown in block 502. Block 502 further is defined by more data subclasses, a representative sample of which is depicted in FIG. 5. Data Fusion (block 524) could also be used on this subclass of data, which would result in a more complete picture of the overall state of medical condition and/or wellness, further annotated by demographic and time information.

Custom Analysis, as shown in block 326, allows a user performing analysis to define the data classes and analysis operations on those classes. In FIG. 5 the case of analysis of demographic data is shown in block 504, defined as a set of operations on the data, from the demographic data perspective. Demographic analysis starts with one or multiple demographic data classes as the base of analysis and then adds additional data points, from the available set of data. As depicted in the figure, analysis could start based on age, as shown in block 506, or culture, as shown in block 508, use all available data classes and then expand by introducing additional data from other data classes, like one of medical subclasses, time information, prescription drug information, etc. This analysis would provide a view into how a particular population segment reacts based on physiological data or the use of some drug, etc. The system may further include a user interface to allow outside access to the anonymised data. For example, a drug company may want to access the continually collected data as part of a drug study. The user interface may further provide the ability for a subscriber to the anonymised data to define their own algorithms for the analysis of collected data. Each subscriber to the anonymised data aspect of the system may be given access to at least a part of the collected data.

The second entry point to the data flow, in FIG. 3, is through User Input as shown in block 358, which is also an exit point, since information is returned back to the user. This is also an interactive data flow. The data flow is initialized by a user who accesses the secure web portal in step 360 to get information, perform analysis or some other action. A user may be the monitored person/entity, a family member of a monitored person, a physician or caregiver of a monitored person, or a company or entity interested in the monitored entity. Access may be initialized through a secure web browser connection. Once connected and authenticated to the site, a user has a number of options, including: Manage Subscription in step 366, Set/Edit Preferences in step 364, and View Subscribed Data in step 362. Through managing the subscription in step 366, a user can renew or cancel the service in step 368, set a different service level, or choose additional options. Through setting or editing preferences in step 360, a user effectively defines the profile to be used for data analysis. This includes settings and thresholds for triggers and the conditions activating them, notification preferences, notification list, contact information.

A user can also view the subscribed data in step 362. Since a user may have subscribed to multiple data classes and subclasses (data channels), access to the data and associated analyses is through the respective data channel, indicated in FIG. 3 as Source 1 . . . . Source n, as shown in blocks 370a, 370b, . . . 370n, respectively, and Custom View 1 . . . . Custom View n, as shown in blocks 372a, 372b, . . . , 372n, respectively. Through those channels the user can access the underlying data and displays for the area of interest and can view current data and historical trends for each subscription channel, plus could use this information to adjust preferences, triggers and notification levels. Through this data flow, a user obtains a complete update on all subscribed data channels, aggregated and transmitted by the data collection sources. This results in situational awareness of the respective data channel at any given point in time and provides decision support for any follow-on actions.

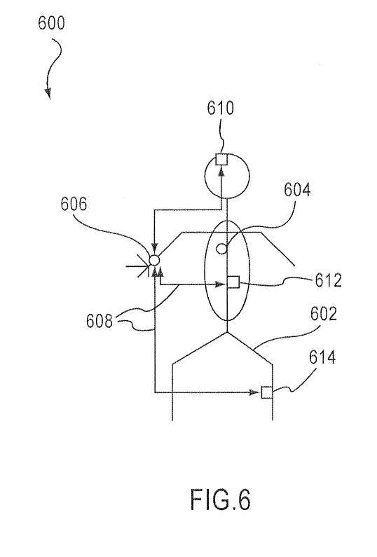

FIG. 6 illustrates system architecture 600 for collecting, analyzing, storing and displaying heterogeneous data, according to an implementation of aspects of the present invention.

System architecture 600, in one exemplary variation, includes a person 602 wearing a simple-to-put-on, lightweight sensor 604 attached to their body to collect the data, along with a body-wearable gateway device (BWGD) 606 to receive the collected data. The collected data may include physiological data, movement data, positional data, and ambient data.

In one variation, sensor 604 is an adhesive patch integrating several miniaturized sensors, which is attached to the body. Sensor 604 includes a microprocessor, a miniaturized power supply, Personal Area Network (PAN) connectivity, sensor control, and some intelligence potential. Sensor 604 obtains heterogeneous data, which can then be processed, encrypted, and aggregated for transmission through a PAN 608 to a gateway device 606 at pre-determined intervals. The personal area network may be a commercial PAN, for example, ZigBee or Bluetooth. However, other personal area networks or even point-to-point communications are possible.

In one implementation, BWGD 606 is a wrist-wearable device integrating several other sensors, a microprocessor, a wireless Personal Area Network hub, software for control of sensors, connectivity and reporting, wireless Local Area Network (LAN) connectivity, cell phone connectivity, and software for intelligent decisions. BWGD 606 processes and encrypts its sensor data, then aggregates this data with the incoming supplied data from the 604 sensor. The microprocessor packages the aggregated data, for example, for transmissions through the LAN at pre-determined or pre-selected intervals.

The system architecture 100 is an open architecture which includes open standards for data and communication enabling communication with various sources. Thus, other sensors and sensor suites, blocks 610-614, may join the personal area network 608, as illustrated in FIG. 6. Therefore, any number of protocols may be used, the majority of which specify an operating frequency range. Other protocols may operate on a single frequency. Transmission protocols may include ZigBee (802.15.4), Cellular (CDMA, GSM and others), Wi-Fi (802.11x), ANT, Bluetooth, and Ultra Wide Band, among others.

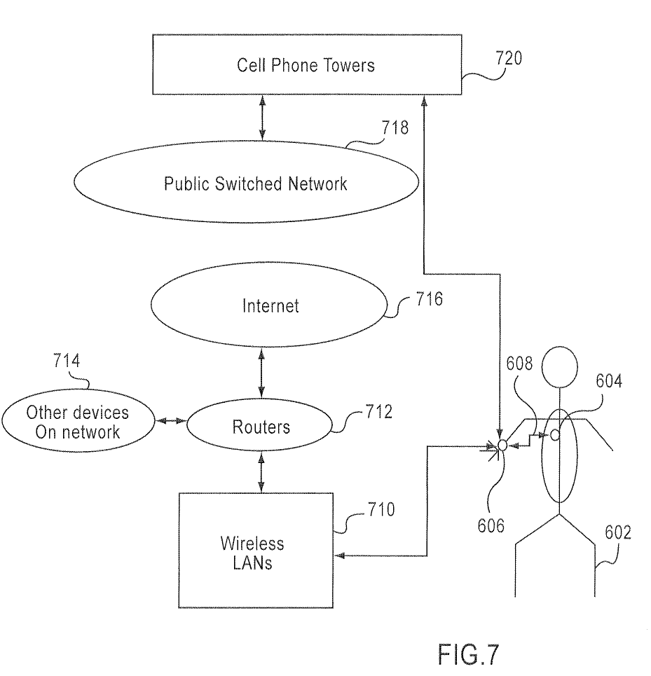

FIG. 7 illustrates system architecture 700 for collecting, analyzing, storing and displaying heterogeneous data, according to a variation of aspects of the present invention. In one variation, when person 602 is inside a home or building, BWGD 606 may be in wireless communication with a wireless LAN 710 for connectivity to the internet 716 to transmit data and voice. Additionally, BWGD 606 may be connected to another source, for example, a cell phone tower 720 to transmit data and voice.

In another variation, when person 602 is outside a home or a building, BWGD 606 may be in wireless communication with a cell phone tower 720 for transmission of data and voice. In addition, when person 602 is outside the home or a building, BWGD 606 may be connected to another source, for example, a LAN 710, for transmission of data and voice.

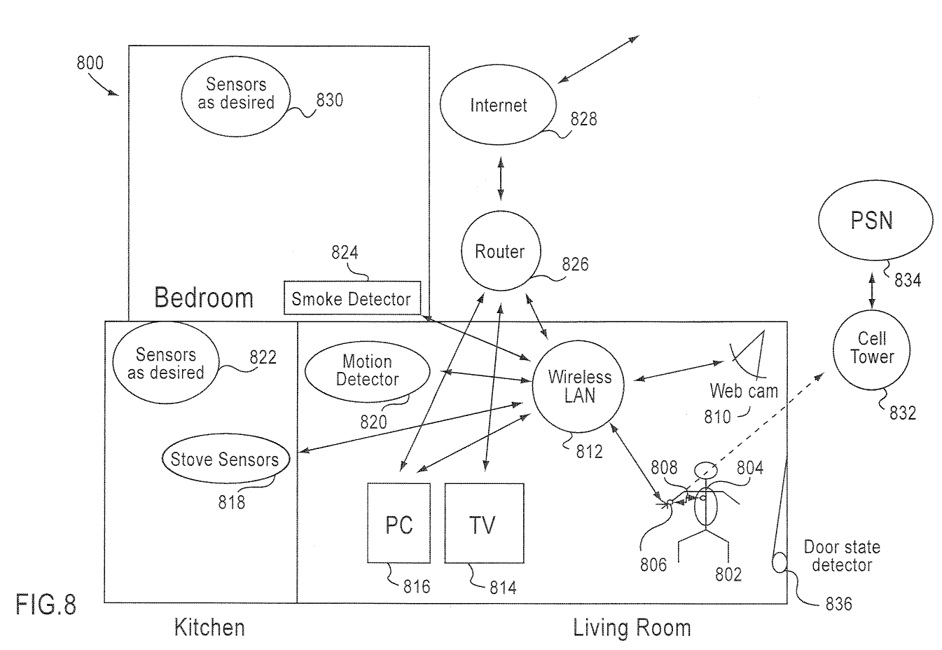

FIG. 8 illustrates system architecture 800 for collecting, analyzing, storing and displaying heterogeneous data, according to a variation of aspects of the present invention. In one implementation, person 802 is connected to a wireless LAN 812 for connectivity to the internet 828 to transmit data and voice through the BWGD 806. Person 802 can also be connected to the cell tower 832 through BWGD 806 to transmit data and voice.

In an implementation, wireless LAN 812 may be connected to a personal computer 816, router 826, stove sensors 818, motion detectors 820, smoke detector 824, a web cam 810, or the like. Additionally, router 826 may be connected to the wireless LAN 812, television 814, personal computer 816, the Internet 828, or the like. As will be appreciated by those skilled in the relevant art(s) after reading the description herein, the wireless LAN 812 may be in communication with one or more networked sets of servers and communication devices for collecting, analyzing, storing and displaying heterogeneous data of one or more persons 802.

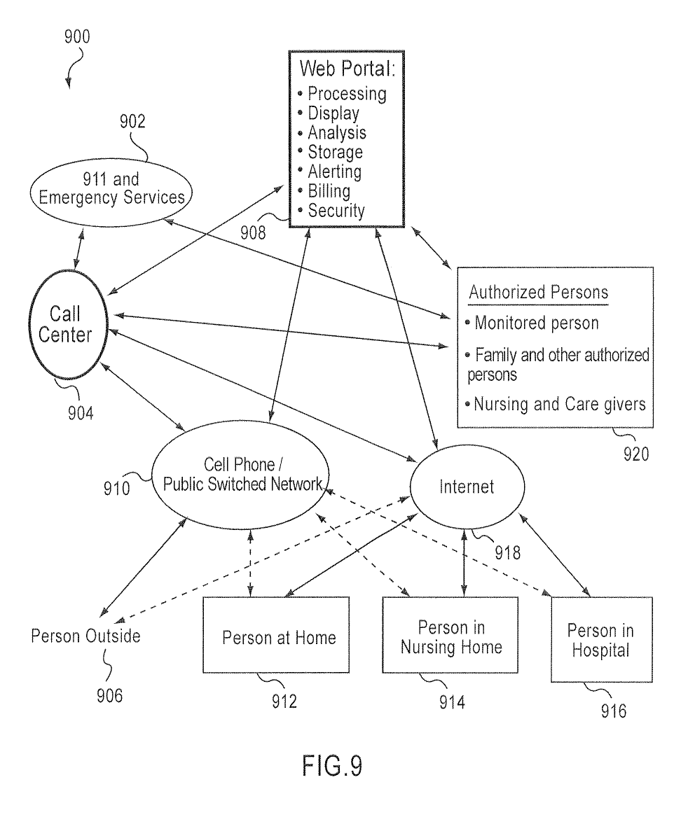

FIG. 9 illustrates system architecture 900 for collecting, analyzing, storing and displaying heterogeneous data, according to aspects of the present invention. In one variation, an internet 918 is receiving data from different collection points. For example, internet 918 is receiving data from a person outside (block 906), a person at home (block 912), a person in the nursing home (block 914) and a person in the hospital (block 916). Additionally, the people mentioned in blocks 906-916, may also be in communication with a cell phone/public switched network 910.

In one variation, the Internet 918, is in wireless communication with a call center 904, where a live operator may respond to the alter trigger sent by a person in one of blocks 906-916 wearing a BWGD 606. This alert may be used, for example, for emergency two-way voice communication between a person 906-912 and personnel at a call center 904. In another variation, a cell phone/public switched telephone network is in communication with a call center 904, where a live operator may respond to the alert trigger sent by person wearing a BWGD 606.

In another variation, the Internet 918 is in communication with a web portal 908. Web portal 908 may process, display, analyze, store, send alerts, set up billing and provide security for data sent from the Internet 918 in a user-friendly interface to support analysis and decision making. Additionally, web portal 908 may be in communication with personnel at a call center 904 and people connected to a cell phone/public switched network 910.

In another variation, the web portal 908 is in communication with authorized persons 920, who may be a person being monitored, family members, caretakers, medical services provider, health care provider, or the like. Such communications may be through wireless communications to a mobile device (e.g., mobile telephone or the like) for display on a personal computer or other device. In an alternative variation, such communication may be between a wide or local area network (WAN or LAN) running a secure communications protocol (e.g., secure sockets layer (SSL)). In another variation, authorized persons 920 may be in communication with personnel at a call center 904 or personnel at emergency services 902.

As will be appreciated by one skilled in the relevant art(s), authorized personnel 920 may receive and interface with data from web portal 908, call center 904 and emergency services 902 using any processing device, including, but not limited to, a desktop computer, laptop, palmtop, workstation, set-top box, mobile telephone, personal data assistant (PDA), or the like.

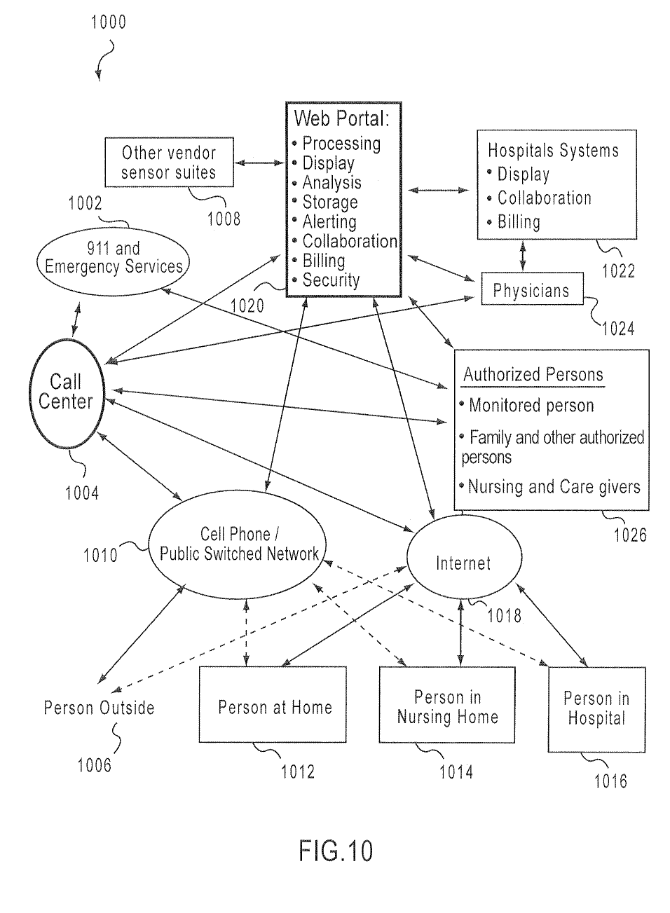

FIG. 10 illustrates system architecture 1000 for collecting, analyzing, storing and displaying heterogeneous data, according to a variation of aspects of the present invention. In addition to the features illustrated in FIG. 9, in one embodiment, a hospital system 1022 is in communication with web portal 1020. Hospital system 1022 may display the information received from web portal 1020, set up billing, or collaborate the data, for example.

Additionally, physicians 1024 may be connected to a hospital system 1022, a web portal 1020 and a call center 1004. Such communications may be through wireless communications to a mobile device (e.g., mobile telephone or the like) for display on a personal computer or other device. In an alternative variation, such communication may be between a wide or local area network (WAN or LAN) running a secure communications protocol (e.g., secure sockets layer (SSL)). As will be appreciated by one skilled in the relevant art(s), physicians 1024 may receive and interface with data from web portal 1020, call center 1004 and hospital systems 1022 using any processing device, including, but not limited to, a desktop computer, laptop, palmtop, workstation, set-top box, mobile telephone, personal data assistant (PDA), or the like.

While this invention has been described in conjunction with the exemplary variation outlined above, various alternatives, modifications, variations, improvements, and/or substantial equivalents, whether known or that are or may be presently unforeseen, may become apparent to those having at least ordinary skill in the art. Accordingly, the exemplary variation of aspects of the present invention, as set forth above, are intended to be illustrative, not limiting. Various changes may be made without departing from the spirit and scope of the invention. Therefore, the present invention is intended to embrace all known or later-developed alternatives, modifications, variations, improvements, and/or substantial equivalents.

In addition, it should be understood that the figures in the attachments, which highlight the structure, methodology, functionality and advantages of aspects of the present invention, are presented for example purposes only. Aspects of the present invention are sufficiently flexible and configurable, such that it may be implemented in ways other than that shown in the accompanying figures.

Further, the purpose of the foregoing Abstract is to enable the U.S. Patent and Trademark Office and the public generally, and especially the scientists, engineers and practitioners in the relevant art(s) who are not familiar with patent or legal terms or phraseology, to determine quickly from a cursory inspection the nature and essence of this technical disclosure. The Abstract is not intended to be limiting as to the scope of aspects of the present invention in any way.

What is claimed is:

1. A system for collecting, analyzing, storing and displaying heterogeneous data comprising:
a first tier of at least one server, wherein the first tier of at least one server is configured to:
receive data provided by at least one system user;
associate the data between the system user and a unique identification number for the system user, wherein the unique identification number is contained within the data; and
parse the data provided by at least one system user into a first data and a second data, wherein the second data retains the unique identification number regarding the system user.

2. The system of claim 1, wherein the first tier of at least one server is further configured to:
anonymise the first data; and
prepare the anoymised data for storage.

3. The system of claim 1, wherein the first tier of at least one server is further configured to:
enable access to the at least one system subscriber;
authenticate the at least one system subscriber;
enable system data analysis by the at least one system subscriber;
enable display of system data to the at least one system subscriber; and
enable editing of system data parameters and data by the at least one system subscriber.

4. The system of claim 3, wherein the first tier of at least one server is further configured to construct alerts based on the second data received from the at least one system user.

5. The system of claim 1, further including a second tier of at least one server, wherein the second tier is in operative communication with the first tier of at least one server, wherein the second tier is further configured to:
respond to at least one request from the first tier of at least one server;
respond to at least one request from at least one system user;
collect, analyze and process the second data;
generate alerts based on the analysis of the second data;
prepare the second data for storage; and
a the third tier of at least one server, wherein the third tier is in operative communication with the second tier of at least one server, wherein the third tier of at least one server is further configured to:
define data models for the storage and retrieval of the second data;
provide access to the second data; and
aggregate raw and processed second data.

6. The system of claim 1, wherein the first tier of at least one server is further configured to receive data wirelessly from a plurality of monitored users.

7. The system of claim 5, wherein the second tier of at least one server is further configured to aggregate and normalize the second data.

8. A method for collecting, analyzing, storing and displaying heterogeneous data in a system comprising:
identifying heterogeneous data;
creating an association between a system user and a unique identification for the system user, wherein the unique identification is contained within the heterogeneous data;
parsing the heterogeneous data into a first data and a second data;
determining the type of heterogeneous data measured;
categorizing the heterogeneous data;
anonymizing the first data;
analyzing the first and second data; and
storing the first and second data.

9. The method of claim 8, further comprising receiving the heterogeneous data from a plurality of sources.

10. The method of claim 8, further comprising determining the source of the heterogeneous data.

11. The method of claim 8, further comprising decrypting the heterogeneous data if decryption is required.

12. The method of claim 8, wherein the first data is stored for one of: operational data analysis and analytical data processing.

13. The method of claim 8, further comprising: monitoring and creating a historical database of the second data of the system user.

14. The method of claim 8, further comprising determining at least one trigger parameter from the user profile.

15. The method of claim 14, further comprising generating an alert upon the activation of at least one trigger parameter.

16. The method of claim 8, further comprising preparing the first and second data for presentation and communication.

17. The method of claim 8, further comprising determining whether it is time to transmit the second data based on a predetermined transmission schedule.

18. The method of claim 8, further comprising aggregating the second data if it is time to transmit.

19. The method of claim 8, further comprising conducting trend analysis on the first data.

20. The method of claim 19, wherein the trend analysis is conducted on a combination of different categories of the first data.

21. The method of claim 8, further comprising
enabling access to the system by at least a system subscriber;
authenticating the at least one system subscriber;
enabling system data analysis by the at least one system subscriber;
enabling display of system data to the at least one system subscriber; and
enabling editing of system data parameters and data by the at least one system subscriber.

22. A computer program product comprising a computer usable medium having control logic stored therein for causing a computer to collect, analyze, store and display heterogeneous data, the control logic comprising:
first computer readable program code means for causing the computer to identify heterogeneous data, wherein the first computer readable program code means comprises control logic for creating an association between a system user and a unique identification for the system user, wherein the unique identification is contained within the heterogeneous data.
second computer readable program code means for parsing the heterogeneous data into a first data and a second data;
third computer readable program code means for causing the computer to determine the type of heterogeneous data measured;
fourth computer readable program code means for causing the computer to categorize the first and second data;
fifth computer readable program code means for causing the computer to analyze the first and second data; and
sixth computer readable program code means for causing the computer to store the first and second data.

23. The computer program product of claim 22, further comprising seventh computer readable program code means for causing the computer to receive the heterogeneous data from a plurality of sources.

24. The computer program product of claim 22, further comprising seventh computer readable program code means for causing the computer to determine the source of the heterogeneous data.

25. The computer program product of claim 22, further comprising seventh computer readable program code means for causing the computer to decrypt the heterogeneous data.

26. The computer program product of claim 22, further comprising seventh computer readable program code means for causing the computer to anonymize the first data.

27. The computer program product of claim 22, wherein the first and second data is stored for one of: operational data analysis and analytical data processing.

28. The computer program product of claim 22, further comprising seventh computer readable program code means for causing the computer to monitor and create a historical database of the first and second data of the system user.

29. The computer program product of claim 22, further comprising seventh computer readable program code means for causing the computer to determine at least one trigger parameter from the user profile.

30. The computer program product of claim 29, further comprising eighth computer readable program code means for causing the computer to generate an alert upon the activation of at least one trigger parameter.

31. The computer program product of claim 22, further comprising seventh computer readable program code means for causing the computer to prepare the first and second data for presentation and communication.

32. The computer program product of claim 22, further comprising seventh computer readable program code means for causing the computer to determine whether it is time to transmit the second data based on a predetermined transmission schedule.

33. The computer program product of claim 32, further comprising eighth computer readable program code means for causing the computer to aggregate the second data if it is time to transmit.

34. The computer program product of claim 22, further comprising seventh computer readable program code means for causing the computer to conduct trend analysis on the first data.

35. The computer program product of claim 34, wherein the trend analysis is conducted on a combination of different categories of the first data.

36. The computer program product of claim 22, further comprising:
seventh computer readable program code means for causing the computer to enable access to the system by at least one system subscriber;
eighth computer readable program code means for causing the computer to authenticate the at least one system subscriber;
ninth computer readable program code means for causing the computer to enable system data analysis by the at least one system subscriber;
tenth computer readable program code means for causing the computer to enable display of system data to the at least one system subscriber; and
eleventh computer readable program code means for causing the computer to enable editing of system data parameters and data by the at least one system subscriber.

37. The system for collecting, analyzing, storing and displaying physiological and other data collected from a plurality of remotely monitored users, the system comprising:
a plurality of wireless monitors configured to be worn by a monitored user, wherein the wireless monitors measure, record and wirelessly transmit physiological data of the monitored person,
a remote operations center configured to receive the transmitted data and to parse the physiological data into first and second data, wherein the first data is anonymised and the second data is associated with personal identification information regarding the monitored user,
a first user interface providing access to the anonymous data; and
a second user interface providing access to a collection of second data for a monitored user.
